(19) United States
(12) Patent Application Publication
(10) Pub. No.: US 2016/0109748 A1
(43) Pub. Date: Apr. 21, 2016

(54) LIGHT-SHIELDING MASK AND METHOD OF FABRICATING LIQUID CRYSTAL DISPLAY DEVICE BY USING THE SAME

(71) Applicant: Samsung Display Co., LTD., Yongin-City (KR)

(72) Inventors: Young Gu KIM, Hwaseong-si (KR); Baek Kyun JEON, Yongin-si (KR); Jae Weon HUR, Busan (KR)

(21) Appl. No.: 14/664,197

(22) Filed: Mar. 20, 2015

(30) Foreign Application Priority Data
Oct. 20, 2014 (KR) 10-2014-0141807

(51) Int. Cl. G02F 1/1335; G02B 5/00; G02F 1/1339

(52) U.S. Cl. CPC G02F 1/133512; G02F 1/1339; G02B 5/003

(57) ABSTRACT

Provided is a light-shielding mask. The light-shielding mask comprises a light-shielding body including a first region and a second region, which surrounds the first region; and the second region is perforated by a plurality of slits.

### CLAIM OF PRIORITY

This application claims the priority to and all the benefits accruing under 35 U.S.C. §119 of Korean Patent Application No. 10-2014-0141807 filed on Oct. 20, 2014 in the Korean Intellectual Property Office (“KIPO”), the disclosure of which is incorporated herein by reference in its entirety.

### BACKGROUND OF THE INVENTION

1. Field of the Invention

The invention relates to a light-shielding mask and a method of fabricating a liquid crystal display (LCD) device by using the same.

2. Description of the Related Art

Liquid crystal display (LCD) panels have been employed not only in televisions (TVs), monitors, and notebook computers, but also in various other devices such as mobile phones, personal digital assistants (PDAs), and smartphones. An LCD panel includes a first display substrate and a second display substrate, which face each other. The first display substrate and the second display substrate are bonded together by a sealing member such as a sealant, and a liquid crystal layer is interposed in the gap between the first display substrate and the second display substrate having alignment layers.

The LCD panel may be divided into a display area where an image is displayed and a non-display area which surrounds the display area. The alignment layers included in the LCD panel are usually formed of materials such as polyimide-based material that have a very high absorption rate of laser in UV spectrum which can cause ablation or complete removal of the alignment material depending on the duration of irradiation or laser pulse duration. During curing of the sealant using UV light, misalignment of the substrate and a light-shielding mask for protecting the alignment layers and the liquid crystal layer from being damaged by irradiation may cause the light applied to cure the sealing member to pass through the display area and reach the alignment layers and the liquid crystal layer, thereby damaging the alignment layers and forming defects such as micro bumps and ring features in the irradiated areas of the alignment layers and damaging the liquid crystal layer by decomposing the liquid crystal material and causing bad alignment of liquid crystals, image sticking, and other optical artifacts commonly referred to as “mura”. The damages of the alignment layers and the liquid crystal layer result in undesired formation of afterimages by the LCD device which deteriorates the display quality of the visible image provided by the LCD device.

### SUMMARY OF THE INVENTION

Exemplary embodiments of the invention provide a method of fabricating a liquid crystal display (LCD) device, which is capable of improving upon the occurrence of border afterimages and border smudges, and a light-shielding mask used in the method.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, there is a light-shielding mask. The light-shielding mask may be constructed with a light-shielding body including a first region and a second region which surrounds the first region; and the second region is perforated by a plurality of slits.

The first region may have a plain pattern and the second region may have a striped pattern formed by alternately arranging the slits and light-shielding portions.

The slits may surround the first region.

The slits may include connecting portions where they are connected to one another.

The first region may have a plain pattern and the second region may have a checkerboard pattern formed by alternately arranging the slits and light-shielding portions.

The light-shielding portions may be connected to one another.

The second region may be provided in a surrounding area of the light-shielding body.

According to another exemplary embodiment of the invention, there is a method of fabricating a liquid crystal display (LCD) device, the method comprises preparing a liquid crystal display (LCD) panel having a display area, which includes substrates, which face each other, a liquid crystal layer, which is interposed between the substrates, and a sealant layer, which is disposed along sides of the liquid crystal layer, and a non-display area, which surrounds the display area; placing a light-shielding mask having a light-shielding body, which includes a first region and a second region surrounding the first region, and slits, which are formed in the second region, on a side of a first surface of the LCD panel; and curing the sealant layer by applying light.

The slits may satisfy Expression (1):

$$1 μm \leq Width of Slits \leq \frac{Distance from Edges of Display Area to Sealant Layer}{2} . \qquad ( 1 )$$

The first region of the light-shielding body may have a plain pattern and the second region of the light-shielding body may have a striped pattern formed by alternately arranging the slits and light-shielding portions.

The slits may surround the first region.

The slits may include connecting portions where they are connected to one another.

The light-shielding portions may satisfy Expression (2):

$$1 μm \leq Width of Light \text{-} Shielding Portions \leq \frac{Distance from Edges of Display Area to Sealant Layer}{2} . \qquad ( 2 )$$

The first region of the light-shielding body may have a plain pattern and the second region of the light-shielding body may have a checkerboard pattern formed by alternately arranging the slits and light-shielding portions.

The light-shielding portions may be connected to one another.

The second region may be provided in a surrounding area of the light-shielding body.

The second region may be provided between sides of the display area and the sealant layer.

The second region may be disposed to partially overlap the sealant layer.

The second region may be disposed to partially overlap the display area.

According to the exemplary embodiments, a sealant is cured by using a light-shielding mask, it is possible to improve border afterimages and border smudges that may be caused in an LCD panel by light applied to cure a sealant layer.

Other features and exemplary embodiments will be apparent from the following detailed description, the drawings, and the claims.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded perspective view illustrating a liquid crystal display (LCD) panel according to an exemplary embodiment of the invention.

FIG. 2 is a cross-sectional view illustrating a method of fabricating an LCD panel, according to an exemplary embodiment of the invention.

FIG. 3 is a layout view illustrating the arrangement of a sealant layer in a first display substrate of an LCD panel of FIG. 2.

FIG. 4 is a plan view illustrating a light-shielding mask according to an exemplary embodiment of the invention.

FIG. 5 is a cross-sectional view taken along line V-V′ of FIG. 4.

FIG. 6 is a diagram showing afterimage test results obtained from an LCD device according to an exemplary embodiment of the invention and from an LCD device according to a comparative example.

FIG. 7 is a diagram showing afterimage test results obtained from an LCD device according to another exemplary embodiment of the invention and from an LCD device according to another comparative example.

FIG. 8 is a plan view illustrating a light-shielding mask according to another exemplary embodiment of the invention.

### DETAILED DESCRIPTION OF THE EMBODIMENTS

Features of the inventive concept and methods of accomplishing the same may be understood more readily by reference to the following detailed description of preferred embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the inventive concept will only be defined by the appended claims.

In the drawings, the thickness of layers and regions are exaggerated for clarity. It will be understood that when an element or layer is referred to as being “on,” “connected to” or “coupled to” another element or layer, the element or layer can be directly on, connected or coupled to another element or layer, or one or more intervening elements or layers may be present. In contrast, when an element is referred to as being “directly on,” “directly connected to” or “directly coupled to” another element or layer, there are no intervening elements or layers present. As used herein, connected may refer to elements being physically, electrically, operably, and/or fluidly connected to each other.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration. As used herein, the terms “use,” “using,” and “used” may be considered synonymous with the terms “utilize,” “utilizing,” and “utilized,” respectively.

Exemplary embodiments will hereinafter be described with reference to the accompanying drawings.

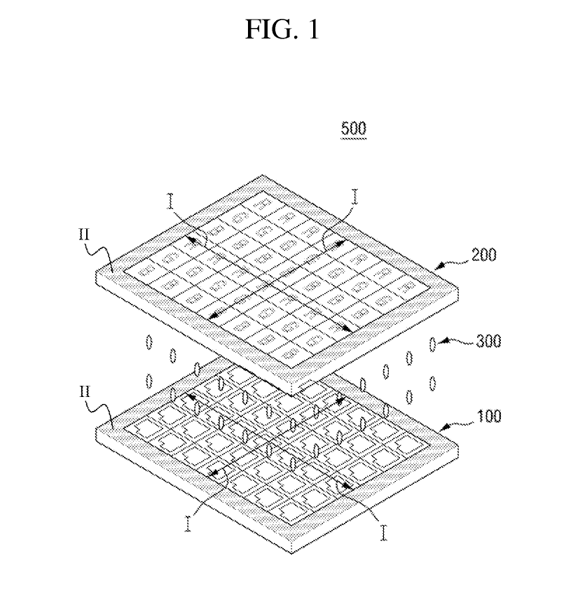

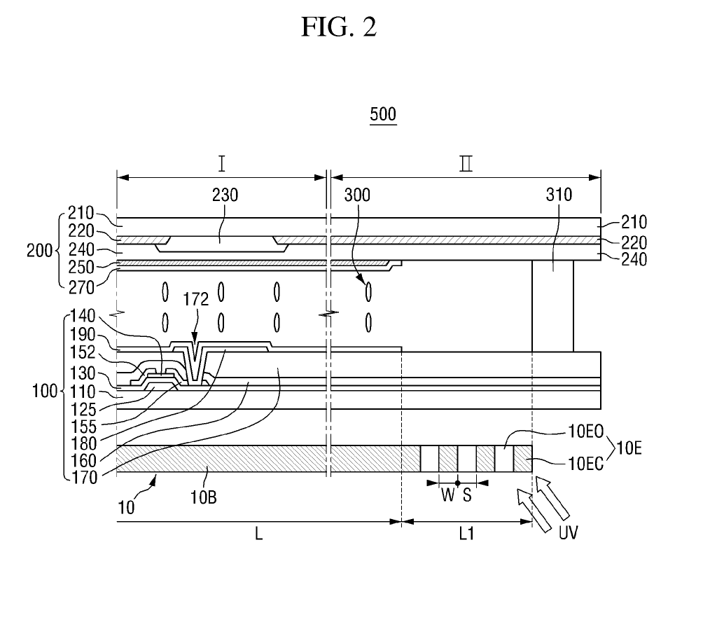

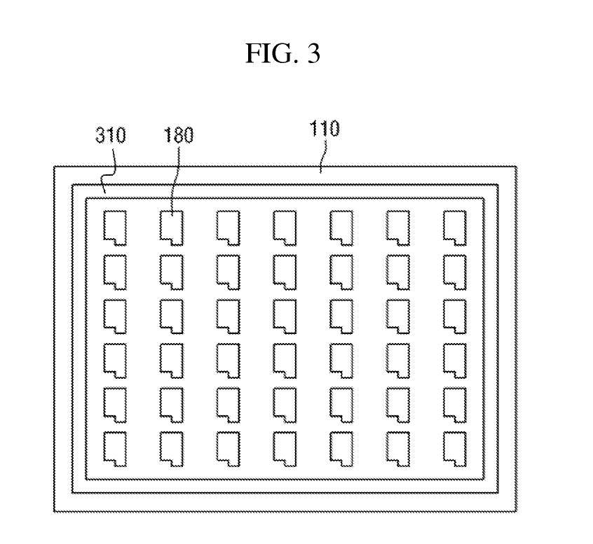

FIG. 1 is an exploded perspective view illustrating a liquid crystal display (LCD) panel according to an exemplary embodiment of the invention, FIG. 2 is a cross-sectional view illustrating a method of fabricating an LCD panel, according to an exemplary embodiment of the invention, and FIG. 3 is a layout view illustrating the arrangement of a sealant layer in a first display substrate of the LCD panel of FIG. 2.

Referring to FIGS. 1 to 3, an LCD panel 500 may include a first display substrate 100, a second display substrate 200, which is isolated from, and faces, the first display substrate 100, and a liquid crystal layer 300, which is interposed between the first display substrate 100 and the second display substrate 200.

Each of the first display substrate 100 and the second display substrate 200 includes a display area I (the region defining the display area I is indicated by the orthogonal double arrow- headed lines) and a non-display area II. In the display area I, a plurality of pixels, which are arranged in a matrix form, may be defined.

A plurality of gate lines, which extend in a first direction, and a plurality of data lines, which extend in a second direction that is perpendicular to the first direction, may be formed on the first display substrate 100 in the display area I.

A pixel electrode 180 may be arranged for each of the plurality of pixels, which are defined by the plurality of gate lines and the plurality of data lines. The pixel electrode 180 may be provided with a data voltage via a thin-film transistor (TFT), which is a switching device. A gate electrode 125, which is the control terminal of the TFT, may be connected to one of the plurality of gate lines, a source electrode 152, which is the input terminal of the TFT, may be connected to one of the plurality of data lines, and a drain electrode 155, which is the output terminal of the TFT, may be connected to the pixel electrode 180 via a contact.

The channel of the TFT may be formed by a semiconductor layer 140. The semiconductor layer 140 may be disposed to overlap the gate electrode 125. The source electrode 152 and the drain electrode 155 may be isolated from each other with the semiconductor layer 140 disposed therebetween. The pixel electrode 180 may form an electric field together with a common electrode 250, and may thus control the orientation of the alignment of liquid crystal molecules in the liquid crystal layer 300, which is disposed between the pixel electrode 180 and the common electrode 250.

The non-display area II, which accounts for the surrounding area of the display area I, may be a region surrounding the display area I. A driving unit for providing a gate driving signal and a data driving signal to each of the plurality of pixels may be provided on the first display substrate 100 in the non-display area II.

A plurality of color filters 230 may be formed on the second display substrate 200 in the display area I for the plurality of pixels, respectively. The color filters 230 may include red, green and blue color filters 230. The red, green and blue color filters 230 may be alternately arranged.

Light-shielding patterns 220 may be disposed along the boundaries among the color filters 230. Light-shielding patterns 220 may also be disposed even in the non-display area II. The light-shielding patterns 220 in the non-display area II may have a greater width than the light-shielding patterns 220 on the boundaries among the color filters 230. The common electrode 250, which formed in one piece for the plurality of pixels, may be disposed on an entire surface of the display area I.

The first display substrate 100 and the second display substrate 200 may be bonded together by a sealant layer or a sealing member 310, which includes a sealant. The sealing member 310 may be provided in the surrounding area of the first display substrate 100 or the second display substrate 200, and particularly, in the non-display area II of the first display substrate 100 or the second display substrate 200.

The LCD panel will hereinafter be described in further detail.

The first display substrate 100 may have a first substrate 110 as a base substrate. The first substrate 110 may include the display area I and the non-display area II. The first substrate 110 may be implemented as a transparent insulating substrate formed of glass or a transparent plastic material.

The plurality of gate lines, which are formed of a conductive material, and the gate electrode 125, which protrudes from one of the plurality of gate lines, are formed on the first substrate 110 in the display area I. Even though not specifically illustrated in the drawings, the plurality of gate lines may also extend into the non-display area II, and may form a plurality of gate pads, respectively, in the non-display area II.

The plurality of gate lines and the gate electrode 125 may be covered by a gate insulating layer 130. The gate insulating layer 130 is also formed in the non-display area II.

The semiconductor layer 140 and an ohmic contact layer (not illustrated) may be formed on the gate insulating layer 130 in the display area I. The source electrode 152, which is branched off from one of the plurality of data lines, and the drain electrode 155, which is isolated from the source electrode 152, may be formed on the semiconductor layer 140 and the ohmic contact layer. Even though not specifically illustrated in the drawings, the plurality of data lines may also extend into the non-display area II, and may form a plurality of data pads, respectively, in the non-display area II.

A passivation layer 160, which is a type of insulating layer formed of an insulating material, such as a silicon nitride layer, a silicon oxide layer, or a silicon oxynitride layer, may be formed on the source electrode 152 and the drain electrode 155, and an organic layer 170, which includes an organic material, may be formed on the passivation layer 160. The passivation layer 160 and the organic layer 170 may also be formed in the non-display area II. The passivation layer 160 is optional.

The pixel electrode 180, which is formed of a conductive material and is provided for one of the plurality of pixels, may be formed on the organic layer 170 in the display area I. The pixel electrode 180 may be electrically connected to the drain electrode 155 via a contact hole 172, which is formed through the organic layer 170 and the passivation layer 160 and exposes the drain electrode 155 therethrough. The pixel electrode 180 may include indium tin oxide (ITO), indium zinc oxide (IZO), indium oxide, zinc oxide, tin oxide, gallium oxide, titanium oxide, aluminum, silver, platinum, chromium, molybdenum, tantalum, niobium, zinc, magnesium, or an alloy or a stack layer thereof.

A liquid crystal alignment layer 190 may be formed on the pixel electrode 180. The liquid crystal alignment layer 190 covers the display area I. The liquid crystal alignment layer 190 may also be formed in an area L, which is extended from the display area I and includes part of the non-display area II. The liquid crystal alignment layer 190 may be treated by rubbing or optical alignment to determine the alignment of liquid crystals. The liquid crystal alignment layer 190 may be formed of a polyimide-based polymer, a cinnamate compound, a coumarine compound, or an azo-based compound with an azobenzene group.

The second display substrate 200 will hereinafter be described. The second display substrate 200 has a second substrate 210 as a base substrate. The second substrate 210 may be implemented as a transparent insulating substrate formed of glass or a transparent plastic material.

The light-shielding patterns 220 are formed on the second substrate 210. The light-shielding patterns 220 may also be formed in the non-display area II.

The color filters 230 may be formed on the light-shielding patterns 220 in the display area I.

An overcoat layer 240 may be formed on the color filters 230 and the light-shielding patterns 220. The overcoat layer 240 may also be formed in the non-display area II.

The common electrode 250 may be disposed on the overcoat layer 240. The common electrode 250 may include ITO, IZO, indium oxide, zinc oxide, tin oxide, gallium oxide, titanium oxide, aluminum, silver, platinum, chromium, molybdenum, tantalum, niobium, zinc, magnesium, or an alloy or a stack layer thereof.

The common electrode 250 may be formed to cover the entire display area I, and may include slits or openings in the display area I. The common electrode 250 may also be formed in part of the non-display area II, but not near the boundaries of the second display substrate 200, and may thus expose the overcoat layer 240.

A liquid crystal alignment layer 270 may be formed on the common electrode 250. The liquid crystal alignment layer 270 covers the common electrode 250. The liquid crystal alignment layer 270 may also be formed in the area L, which is extended from the display area I and includes part of the non-display area II. The liquid crystal alignment layer 270 may be treated by rubbing or optical alignment to determine the alignment of liquid crystals. The liquid crystal alignment layer 270 may be formed of a polyimide-based polymer, a cinnamate compound, a coumarine compound, or an azo-based compound with an azobenzene group.

The first display substrate 100 and the second display substrate 200 may be disposed to face each other with a predetermined cell gap maintained therebetween. The liquid crystal layer 300 may be interposed between the first display substrate 100 and the second display substrate 200 in the display area I. The liquid crystal alignment layer 190 or 270 may be formed on at least one of the surfaces of the first display substrate 100 or the second display substrate 100 that contacts the liquid crystal layer 300. The pixel electrode 180 of the first display substrate 100 and the common electrode 250 of the second display substrate 200 may be disposed to face each other and may form an electric field in the liquid crystal layer 300.

In the non-display area II of the LCD panel 500, the sealing member 310, which includes a sealant, is formed. The sealing member 310 may be formed along the boundaries of ii the display area I, and may surround the display area I. Accordingly, the sealing member 310 not only bonds the first display substrate 100 and the second display substrate 200 together, but also defines a predetermined space between the first display substrate 100 and the second display substrate 200. The liquid crystal layer 300 may be inserted in the predetermined space, and as a result, the liquid crystal molecules in the liquid crystal layer 300 may be prevented from leaking out of the LCD panel 500.

In the first display substrate 100 in the non-display area II, the first substrate 110, the gate insulating layer 130, the passivation layer 160 and the organic layer 170 are sequentially formed. In part of the non-display area II, the liquid crystal alignment layer 190 is formed on the organic layer 170. In the second display substrate 200 in the non-display area II, the second substrate 210, the light-shielding patterns 220 and the overcoat layer 240 are sequentially formed. In part of the non-display area II, the common electrode 250 and the liquid crystal alignment layer 270 are sequentially formed on the overcoat layer 240.

The sealing member 310 and the edges of the liquid crystal alignment layer 190 or 270 are isolated from each other by a predetermined distance. The space between the sealing member 310 and the liquid crystal alignment layer 190 or 270 will hereinafter be referred to as a liquid crystal alignment layer margin L1.

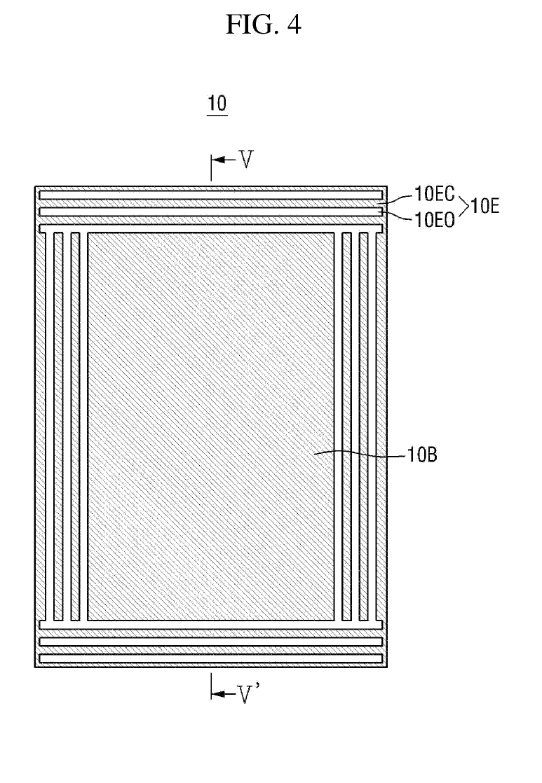

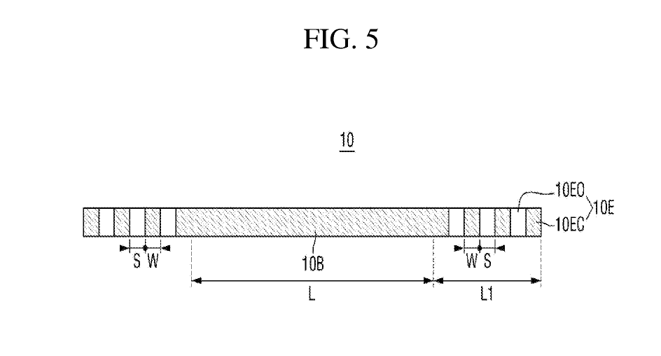

FIG. 4 is a plan view illustrating a light-shielding mask according to an exemplary embodiment of the invention, and FIG. 5 is a cross-sectional view taken along line V-V′ of FIG. 4.

Referring to FIGS. 2, 4 and 5, a light-shielding mask 10 is disposed below the LCD panel 500. The light-shielding mask 10 blocks the transmission of light emitted from therebelow. Light for curing a sealant may be ultraviolet (UV) light with a wavelength of 365 nm, but the invention is not limited thereto.

The light-shielding mask 10 may include a first region 10B and a second region 10E, which is provided in the surrounding area of the first region 10B. The first region 10B is a light-shielding region that blocks the transmission of light therethrough, and the second region 10E includes slits 10EO through which light can be transmitted, and light-shielding portions 10EC, which block the transmission of light therethrough.

The first region 10B protects the display area I from light emitted from below the light-shielding mask 10. The liquid crystal alignment layers 190 and 270 and the liquid crystal layer 300 in the display area I are not damaged by light emitted from below the light-shielding mask 10. The first region 10B may be provided to overlap the area L, which includes the display area I and part of the non-display area II. The liquid crystal alignment layers 190 and 270 in the non-display area II are protected by the first region 10B.

The second region 10E is provided in an area that overlaps the liquid crystal alignment layer margin L1. The second region 10E may reduce the amount of light applied from below the light-shielding mask 10 to the non-display area II to the display area I, and may thus minimize damage to the liquid crystal layer 300 and the liquid crystal alignment layers 190 and 270, caused by light applied during the curing of a sealant.

Due to a misalignment of the light-shielding mask 10, the second region 10E may partially overlap the display area I or the sealing member 310. In this case, since the slits 10EO and the light-shielding portions 10EC are alternately arranged in the second region 10E, damage to the liquid crystal layer 300 and the liquid crystal alignment layers 190 and 270 in the display area I, caused by UV light, may be minimized.

In the second region 10E, the slits 10EO and the light-shielding portions 10EC are alternately arranged. FIGS. 4 and 5 illustrate that the second region 10E begins from the edges of the first region 10B with a light-shielding portion 10EC and a slit 10EO alternately arranged, but the invention is not limited thereto. That is, it would be obvious to a person skilled in the art that a configuration in which a slit 10EO and a light-shielding portion 10EC are alternately arranged, starting from the edges of the first region 10B, is also within the scope of the invention.

The first region 10B is formed in a plain pattern, and the second region 10E is formed in a striped pattern. The slits 10EO and the light-shielding portions 10EC may be arranged to form stripes in the second region 10E. The slits 10EO may be formed to surround the edges of the first region 10B.

The slits 10EO may form a multi-slit structure, which includes connecting portions where the slits 10EO are connected to one another, but the invention is not limited thereto. That is, the slits 10EO may be formed in the form of islands that are separate from one another, in which case, the light-shielding portions 10EC may be connected to one another.

The width of the slits 10EO may be determined to satisfy Expression (1):

$$1 μm \leq Width of Slits \leq \frac{Distance from Edges of Display Area to Sealant Layer}{2} . \qquad ( 1 )$$

In response to the width of the slits 10EO being less than 1 μm, the sealing member 310 may not be able to be properly exposed to light emitted from below the light-shielding mask 10 to the display area I to the non-display area II. On the other hand, in response to the width of the slits 10EO being greater than 50% of the distance between the edges of the display area I and the sealing member 310, the liquid crystal layer 300 and the liquid crystal alignment layers 190 and 270 in the display area may be damaged by light emitted from below the light-shielding mask 10 to the non-display area II to the display area I.

The width of the light-shielding portions 10EC may be determined to satisfy Expression (2):

$$1 μm \leq Width of Light \text{-} Shielding Portions \leq \frac{Distance from Edges of Display Area to Sealant Layer}{2} . \qquad ( 2 )$$

In response to the width of the light-shielding portions 10EC being less than 1 μm, the liquid crystal layer 300 and the liquid crystal alignment layers 190 and 270 in the display area may be damaged by light emitted from below the light-shielding mask 10 to the non-display area II to the display area I. On the other hand, in response to the width of the light-shielding portions 10EC being greater than 50% of the distance between the edges of the display area I and the sealing member 310, the amount of light emitted from below the light-shielding mask 10 to the display area I to the non-display area II may be reduced. As a result, the amount of time that it takes to cure the sealing member 310 may increase, or the sealing member 310 may not be able to be properly cured.

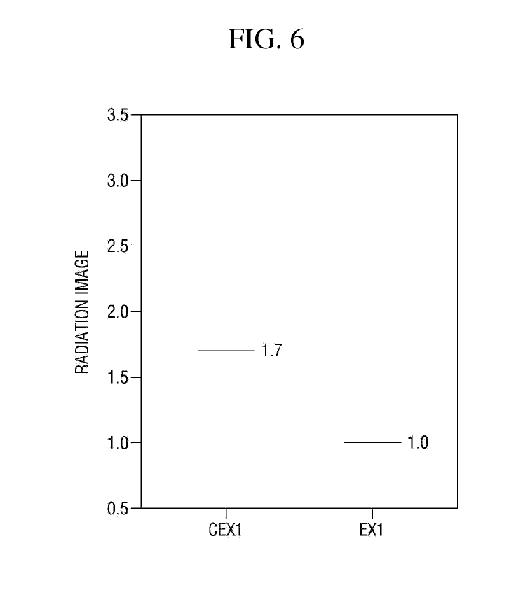

FIG. 6 is a diagram showing afterimage test results obtained from an LCD device according to an exemplary embodiment of the invention and from an LCD device according to a comparative example.

Referring to FIGS. 2 and 6, an LCD device according to comparative example 1 (CEX1) was prepared by placing a light-shielding mask including the first region 10B only and having a size corresponding to the size of the display area I of the LCD panel 500, which includes the liquid crystal layer 300 having liquid crystal molecules with positive dielectric anisotropy, below the LCD panel 500 and applying UV light so as to cure the sealing member 310 of the LCD panel 500, and an LCD device according to exemplary embodiment 1 (EX1) was prepared by placing the light-shielding mask 10 including both the first region 10B and the second region 10E below the LCD panel 500, which includes the liquid crystal layer 300 having liquid crystal molecules with positive dielectric anisotropy, and applying UV light so as to cure the sealing member 310 of the LCD panel 500.

The light-shielding mask used in comparative example 1 (CEX1) differs from the light-shielding mask 10 used in exemplary embodiment 1 (EX1) in that it cannot cover part of the LCD panel 500 overlapping the liquid crystal alignment layer margin L1.

A white grayscale voltage and a black grayscale voltage were applied to the LCD device according to comparative example 1 (EX1) and the LCD device according to exemplary embodiment 1 (EX1), respectively, so as to form checkerboard patterns in white and black grayscales, respectively. Thereafter, a gray grayscale voltage was applied to the white grayscale of the LCD device according to comparative example 1 (EX1) and the black grayscale of the LCD device according to exemplary embodiment 1 (EX1). Thereafter, residual images in a white grayscale were measured.

As shown in FIG. 6, the LCD device according to comparative example 1 (CEX1) has an average border afterimage visibility value of 1.7, whereas the LCD device according to exemplary embodiment 1 (EX1) has an average border afterimage visibility value of 1.0. That is, the LCD device according to exemplary embodiment 1 (EX1) has an improved border afterimage effect as compared to the LCD device according to comparative example 1 (CEX1).

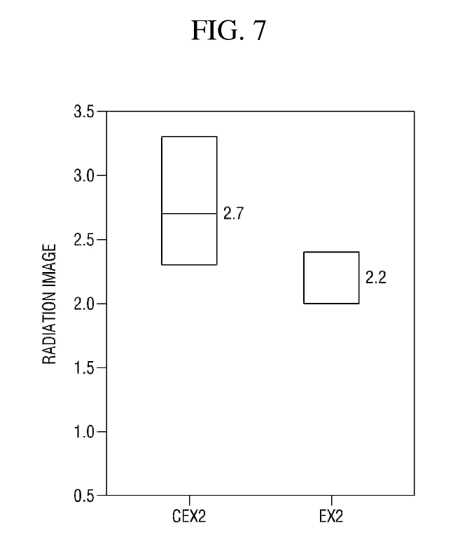

FIG. 7 is a diagram showing afterimage test results obtained from an LCD device according to another exemplary embodiment of the invention and from an LCD device according to another comparative example.

Referring to FIGS. 2 and 7, an LCD device according to comparative example 2 (CEX2) was prepared by placing a light-shielding mask including the first region 10B only and having a size corresponding to the size of the display area I of the LCD panel 500, which includes the liquid crystal layer 300 having liquid crystal molecules with negative dielectric anisotropy, below the LCD panel 500 and applying UV light so as to cure the sealing member 310 of the ii LCD panel 500, and an LCD device according to exemplary embodiment 2 (EX2) was prepared by placing the light-shielding mask 10 including both the first region 10B and the second region 10E below the LCD panel 500, which includes the liquid crystal layer 300 having liquid crystal molecules with negative dielectric anisotropy, and applying UV light so as to cure the sealing member 310 of the LCD panel 500.

The light-shielding mask used in comparative example 2 (CEX2) differs from the light-shielding mask 10 used in exemplary embodiment 2 (EX2) in that it cannot cover part of the LCD panel 500 overlapping the liquid crystal alignment layer margin L1.

A white grayscale voltage and a black grayscale voltage were applied to the LCD device according to comparative example 2 (EX2) and the LCD device according to exemplary embodiment 2 (EX2), respectively, so as to form checkerboard patterns in white and black grayscales, respectively. Thereafter, a gray grayscale voltage was applied to the white grayscale of the LCD device according to comparative example 2 (EX2) and the black grayscale of the LCD device according to exemplary embodiment 2 (EX2). Thereafter, residual images in a white grayscale were measured.

As shown in FIG. 7, the LCD device according to comparative example 2 (CEX2) has an average border afterimage visibility value of 2.7, whereas the LCD device according to exemplary embodiment 2 (EX2) has an average border afterimage visibility value of 2.2. That is, the LCD device according to exemplary embodiment 2 (EX2) has an improved border afterimage effect as compared to the LCD device according to comparative example 2 (CEX2).

A light-shielding mask 11 according to another exemplary embodiment of the invention will hereinafter be described. The functions of parts of the light-shielding mask 11 are the same as the functions of their respective counterparts of the light-shielding mask 10, and thus, detailed descriptions thereof will be omitted or simplified.

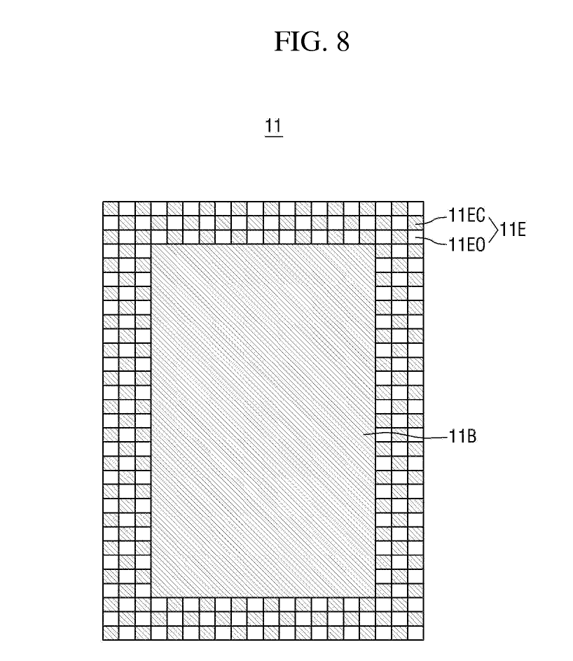

FIG. 8 is a plan view illustrating the light-shielding mask 11.

Referring to FIG. 8, the light-shielding mask 11 is identical to the light-shielding mask 10 in that it includes a first region 11B formed in a plain pattern, but differs from the light-shielding mask 10 in that it includes a second region 11E formed in a checkerboard pattern.

In the second region 11E, light-shielding portions 11EC and slits 11EO are alternately arranged to form the checkerboard pattern. The light-shielding portions 11EC are connected to one another. The slits 11EO are formed in the form of islands that are isolated from one another.

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. A light-shielding mask, comprising:
a light-shielding body including a first region and a second region, which surrounds the first region; and
the second region is perforated by a plurality of slits,
the slits include connecting portions where at least one of the slits at one side of the first region are connected to at least one of the slits at another side of the first region.

2. The light-shielding mask of claim 1, the first region has a plain pattern and the second region has a striped pattern formed by alternately arranging the slits and light-shielding portions.

3. The light-shielding mask of claim 2, the slits are further configured to surround the first region.

4. A light-shielding mask, comprising:
a light-shielding body including a first region and a second region, which surrounds the first region; and
the second region is perforated by a plurality of slits.

5. The light-shielding mask of claim 4, the first region has a plain pattern and the second region has a checkerboard pattern formed by alternately arranging the slits and light-shielding portions.

6. The light-shielding mask of claim 5, the light-shielding portions are connected to one another.

7. The light-shielding mask of 1, the second region is provided in a surrounding area of the light-shielding body.

8. The light-shielding mask of 4, the second region is provided in a surrounding area of the light-shielding body.

9. A method of fabricating a liquid crystal display (LCD) device, the method comprising:
preparing a liquid crystal display (LCD) panel having a display area, which includes substrates, which face each other, a liquid crystal layer, which is interposed between the substrates, and a sealant layer, which is disposed along sides of the liquid crystal layer, and a non-display area, which surrounds the display area;
placing a light-shielding mask having a light-shielding body, which includes a first region and a second region surrounding the first region, and slits, which are formed in the second region, on a side of a first surface of the LCD panel; and
curing the sealant layer by applying light.

10. The method of claim 9, the slits satisfy Expression (1):
$$1 μm \leq Width of Slits \leq \frac{Distance from Edges of Display Area to Sealant Layer}{2} . \qquad ( 1 )$$

11. The method of claim 10, the first region of the light-shielding body has a plain pattern and the second region of the light-shielding body has a striped pattern formed by alternately arranging the slits and light-shielding portions.

12. The method of claim 11, the slits surround the first region.

13. The method of claim 11, the slits include connecting portions where they are connected to one another.

14. The method of claim 11, the light-shielding portions satisfy Expression (2):
$$1 μm \leq Width of Light \text{-} Shielding Portions \leq \frac{Distance from Edges of Display Area to Sealant Layer}{2} . \qquad ( 2 )$$

15. The method of claim 9, the first region of the light-shielding body has a plain pattern and the second region of the light-shielding body has a checkerboard pattern formed by alternately arranging the slits and light-shielding portions.

16. The method of claim 15, the light-shielding portions are connected to one another.

17. The method of claim 9, the second region is provided in a surrounding area of the light-shielding body.

18. The method of claim 9, the second region is provided between sides of the display area and the sealant layer.

19. The method of claim 9, the second region is disposed to partially overlap the sealant layer.

20. The method of claim 9, the second region is disposed to partially overlap the display area.
